(19) United States
(12) Patent Application Publication
(10) Pub. No.: US 2024/0217156 A1
(43) Pub. Date: Jul. 4, 2024

(54) STABILIZATION LAYERS IN FLEXIBLE PROFILE/CONDUIT PROCESSING AND APPLICATIONS

(71) Applicant: Dura-Line LLC, Knoxville, TN (US)

(72) Inventors: Sam Lukubira, Knoxville, TN (US); Caleb Michael Spradling, Knoxville, TN (US); Gordon Mikel Roark, Harrogate, TN (US); Arturo Valencia, Farragut, TN (US)

(21) Appl. No.: 18/147,137

(22) Filed: Dec. 28, 2022

(51) Int. Cl. B29C 48/21

(52) U.S. Cl. CPC B29C 48/21; B29C 2791/003; B29C 2948/922; B29K 2023/065

(57) ABSTRACT

A conduit including a first concentric layer and a second concentric layer that are coextruded, the first concentric layer having a higher melt viscosity than the second concentric layer, and the first concentric layer being of a thickness of at least 3% of a combined thickness of the first and second concentric layers, is provided. Conduits further including third and fourth concentric layers and conduits further including at least one microduct within a lumen defined by the first concentric layer are further provided.

### TECHNICAL FIELD

The present disclosure relates to conduits. More particularly, the disclosure relates to flexible, multi-layer polymeric conduits.

### BACKGROUND

The flexible pipe and conduit manufacturing industry predominantly uses polyolefins in pipes and conduits due the versatility and case of processability of polyolefins. However, certain applications present environmentally challenging circumstances beyond the material capacity of polyolefins. Applications that may be beyond the material capacity of polyolefins include the trenchless installation of communication and power lines along large oil transport pipes for system monitoring.

Trenchless methods, like Horizontal Direction Drilling (“HDD”), are utilized in infrastructure installation projects for which open trenching is not feasible, including, for example, crossing under busy highways, and under rivers. Trenchless installations present large abrasion forces and point loads that may cause the failure of standard ducts made from high-density polyethylene (“HDPE”). One solution involves the use of stainless steel tubes. However, stainless steel tubes are rigid, and require additional tools for straightening, which reduces the pace of the installation process. Further, metallic ducts may interfere with some telecommunication applications, such as optical fiber sensing.

For environments in which metallic ducts create problems, engineering polymers may be used to prepare ducts. However, converting such engineering polymers into pipes and conduits may be challenging due to the intrinsic physical properties of the polymers, including the hypersensitivity of the polymers to variables such as temperature, shear, and moisture, which may compromise processability and dimensional uniformity. Engineering polymers may consequently fail to provide uniform wall thicknesses.

Thus, there is a need for conduits that may resist large abrasion forces and point loads. Further, there is a need for conduits that have low-temperature toughness. Further, there is a need for conduits with excellent compressive recovery that may recover 80% of inner diameter to enable cable install even when flattened. Further, there is a need for conduits with insulative properties.

There is a need to employ various functional polymers, beyond polyolefins, in conduits such that various, technically challenging polymers may be reliably co-extruded with desirable dimensional integrity.

### SUMMARY

In an example, the present disclosure provides a conduit. The conduit includes a first concentric layer, including a first outer surface and defining a lumen extending therethrough. The conduit further includes a second concentric layer at least partially enveloping the first outer surface. The first concentric layer and the second concentric layer are coextruded. A first melt viscosity of the first concentric layer is higher than a second melt viscosity of the second concentric layer. A thickness of the first concentric layer is at least 3% of a combined thickness of the first and second concentric layers of the conduit.

In another example, the first melt viscosity may be at least ten times higher than the second melt viscosity.

In yet another example, the first concentric layer may include a polyamide (“PA”), polyvinyl chloride (“PVC”), polybutylene terephthalate (“PBT”), polyethylene terephthalate (“PET”), polystyrene (“PS”), polypropylene (“PP”), polyvinylidene fluoride (“PVDF”), polytetrafluoroethylene (“PTFE”), polyethylene oxide (“PEO”), high-density polyethylene (“HDPE”), or combinations thereof.

In yet another example, the first concentric layer may include a polyamide including PA6, PA11, PA12, PA46, PA66, or combinations thereof.

In yet another example, the second concentric layer may include thermoplastic polyurethane (“TPU”), thermoplastic elastomer (“TPE”), poly-2,6-dimethylphenylene oxide (“PPO”), polyvinyl methyl ether, polyvinyl chloride (PVC), polyetherimide (“PEI”), polymethyl methacrylate (“PMMA”), polyacrylic acid (PAA), polyether ketone, or combinations thereof.

In yet another example, the first concentric layer may include PA12 and the second concentric layer may include TPU.

In yet another example, the first concentric layer may include HDPE and the second concentric layer may include TPU.

In yet another example, the first concentric layer may include PP and the second concentric layer may include TPE.

In yet another example, the thickness of the first concentric layer may be at least 10% of the combined thickness.

In yet another example, the thickness of the first concentric layer may be at least 20% of the combined thickness.

In yet another example, the thickness of the first concentric layer may be at least 30% of the combined thickness.

In yet another example, the second concentric layer may be in direct contact with the first concentric layer.

In yet another example, the conduit may be without a tie layer between the first concentric layer and the second concentric layer.

In yet another example, the conduit may further include a third concentric layer including a third outer surface, the third concentric layer at least partially enveloping a second outer surface of the second concentric layer. The conduit may further include a fourth concentric layer at least partially enveloping the third concentric layer. The third concentric layer and the fourth concentric layer may be coextruded. A third melt viscosity of the third concentric layer may be higher than a fourth melt viscosity of the fourth concentric layer. A combined two-layer thickness of the first concentric layer and the third concentric layer may be at least 3% of a combined four-layer thickness of the first, second, third, and fourth concentric layers of the conduit.

In yet another example, the third melt viscosity may be at least ten times higher than the fourth melt viscosity.

In yet another example, the third concentric layer may include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTPE), polyethylene oxide (PEO), high-density polyethylene (HDPE), or combinations thereof.

In yet another example, the third concentric layer may include a polyamide including PA6, PA11, PA12, PA46, PA66, or combinations thereof.

In yet another example, the fourth concentric layer may include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

In yet another example, the third concentric layer may include PA12 and the fourth concentric layer may include TPU.

In yet another example, the third concentric layer may include HDPE and the fourth concentric layer may include TPU.

In yet another example, the third concentric layer may include PP and the fourth concentric layer may include TPE.

In yet another example, the combined two-layer thickness may be at least 10% of the combined four-layer thickness.

In yet another example, the combined two-layer thickness may be at least 20% of the combined four-layer thickness.

In yet another example, the combined two-layer thickness may be at least 30% of the combined four-layer thickness.

In yet another example, the fourth concentric layer may be in direct contact with the third concentric layer.

In yet another example, the third concentric layer may be in direct contact with the second concentric layer.

In yet another example, the conduit may be without a tie layer between the third concentric layer and the fourth concentric layer.

In yet another example, the conduit may be without a tie layer between the third concentric layer and the second concentric layer.

In yet another example, the conduit may further include at least one microduct extending through the lumen.

In yet another example, the at least one microduct each may include an inner microduct concentric layer including an inner microduct outer surface and a microduct lumen extending therethrough. The at least one microduct each may include an outer microduct concentric layer at least partially enveloping the inner microduct outer surface. The inner microduct concentric layer and the outer microduct concentric layer may be coextruded. An inner microduct melt viscosity of the inner microduct concentric layer may be higher than an outer microduct melt viscosity of outer microduct concentric layer. An inner microduct thickness of the inner microduct concentric layer may be at least 3% of a combined thickness of the inner and outer concentric layers of the at least one microduct.

In yet another example, the conduit may further include at least one cable disposed in the microduct lumen.

In yet another example, the cable may be selected from the group consisting of communications cable, power cable, and combinations thereof.

In yet another example, the inner microduct melt viscosity may be at least ten times higher than the outer microduct melt viscosity.

In yet another example, the inner microduct concentric layer may include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof.

In yet another example, the inner microduct concentric layer may include a polyamide including PA6, PA11, PA12, PA46, PA66, or combinations thereof.

In yet another example, the outer microduct concentric layer may include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

In yet another example, the inner microduct concentric layer may include PA12 and the outer microduct concentric layer may include TPU.

In yet another example, the inner microduct concentric layer may include HDPE and the outer microduct concentric layer may include TPU.

In yet another example, the inner microduct concentric layer may include PP and the outer microduct concentric layer may include TPE.

In yet another example, the inner microduct thickness may be at least 10% of the combined thickness of the inner and outer microduct concentric layers.

In yet another example, the inner microduct thickness may be at least 20% of the combined thickness of the inner and outer microduct concentric layers.

In yet another example, the inner microduct thickness may be at least 30% of the combined thickness of the inner and outer microduct concentric layers.

In yet another example, the inner microduct concentric layer may be in direct contact with the outer microduct concentric layer.

In yet another example, the conduit may be without a tie layer between the inner microduct concentric layer and the outer microduct concentric layer.

In yet another example, the present disclosure provides an oversheath. The oversheath includes a first concentric layer, including a first outer surface and defining a lumen extending therethrough. The oversheath further includes a second concentric layer at least partially enveloping the first outer surface. The oversheath further includes at least one conduit extending through the lumen. The at least one conduit each include an inner conduit concentric layer, including a conduit outer surface and a conduit lumen extending therethrough. The at least one conduit each further include an outer conduit concentric layer at least partially enveloping the inner conduit concentric layer. The first concentric layer and the second concentric layer are coextruded. The inner conduit concentric layer and the outer conduit concentric layer are coextruded. A first melt viscosity of the first concentric layer is higher than a second melt viscosity of the second concentric layer. An inner conduit melt viscosity of the inner conduit concentric layer is higher than an outer conduit melt viscosity of the outer conduit concentric layer. A thickness of the first concentric layer is at least 3% of a combined thickness of the first and second concentric layers of the oversheath. An inner conduit thickness of the inner conduit concentric layer is at least 3% of a combined thickness of the inner and outer conduit concentric layers of the at least one conduit. The first concentric layer and the inner conduit concentric layer each independently include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof. The second concentric layer and the outer conduit concentric layer each independently include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the present disclosure may be well understood, there will now be described various forms thereof, given by way of example, reference being made to the accompanying drawings. The components in the figures are not necessarily to scale. Moreover, in the figures, like-referenced numerals designate corresponding parts through the different views.

FIG. 1A illustrates a perspective view of an example of a conduit, in accordance with the principles of the present disclosure;

FIG. 1B illustrates a cross-sectional view of the example of the conduit illustrated in FIG. 1A;

FIG. 2A illustrates a perspective view of another example of a conduit, including a third concentric layer and a fourth concentric layer, in accordance with the principles of the present disclosure;

FIG. 2B illustrates a cross-sectional view of the example of the conduit illustrated in FIG. 2A;

FIG. 3A illustrates a perspective view of yet another example of a conduit, including microducts within the lumen of the conduit, in accordance with the principles of the present disclosure;

FIG. 3B illustrates a cross-sectional view of the example of the conduit illustrated in FIG. 3A:

FIG. 4 illustrates a comparison of the viscosity-oscillation frequency data for PA12 to the viscosity-oscillation frequency data for pipe-grade HDPE resin and TPU functional material;

FIG. 5 illustrates crush force-deformation of a PA12-TPU conduit compared to a conduit made from HDPE;

FIG. 6 illustrates a cross-sectional view of another example of a microduct including a plurality of ribs, in accordance with the principles of the present disclosure; and

FIG. 7 illustrates a cross-sectional view of another example of a conduit, including the example of at least one microduct illustrated in FIG. 6 within the lumen of the conduit, in accordance with the principles of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses.

The uses of the terms “a” and “an” and “the” and similar referents in the context of describing the present disclosure (especially in the context of the following claims) are to be construed to cover both the singular and the plural, unless otherwise indicated herein or clearly contradicted by context. The use of the term “plurality of” is defined by the Applicant in the broadest sense, superseding any other implied definitions or limitations hereinbefore or hereinafter unless expressly asserted by Applicant to the contrary, to mean a quantity of more than one. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

As used herein in the terms “comprise(s),” “include(s),” “having,” “has,” “can,” “contain(s),” and variants thereof, are intended to be open-ended transitional phrases, terms, or words that do not preclude the possibility of additional acts or structures. The present description also contemplates other examples “comprising,” “consisting,” and “consisting essentially of,” the examples or elements presented herein, whether explicitly set forth or not.

In describing elements of the present disclosure, the terms 1^{st}, 2^{nd}, first, second, A, B, (a), (b), and the like may be used herein. These terms are only used to distinguish one element from another element, but do not limit the corresponding elements irrespective of the nature or order of the corresponding elements.

Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art.

As used herein, the term “about,” when used in the context of a numerical value or range set forth means a variation of ±15%, or less, of the numerical value. For example, a value differing by ±15%, ±14%, ±10%, or ±5%, among others, would satisfy the definition of “about,” unless more narrowly defined in particular instances.

As used herein, the terms “melt viscosity” and “complex viscosity” refer to a measure, at a given temperature, of the rate at which chains of a polymer may move relative to each other. The rate at which chains of a polymer may move relative to each other may be controlled by the case of rotation about the backbone bonds and the degree of entanglement of the chains.

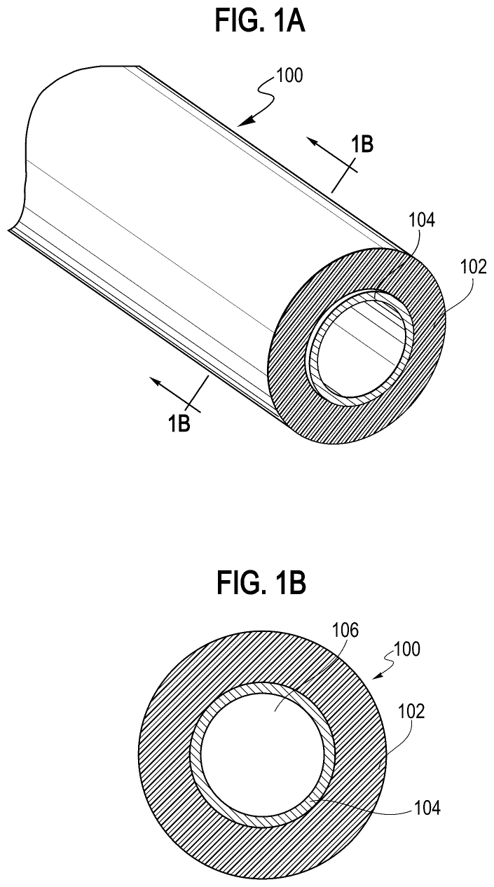

Referring to FIG. 1A, a perspective view of an example of a conduit 100 is illustrated. Conduit 100 includes a first concentric layer 104. First concentric layer 104 includes a first outer surface and defines a lumen 106 extending through first concentric layer 104. Second concentric layer 102 at least partially envelops the first outer surface. First concentric layer 104 and second concentric layer 102 may be coextruded. A melt viscosity of first concentric layer 104 may be higher than a melt viscosity of second concentric layer 102. A thickness of first concentric layer 104 is at least 3% of a combined thickness of first concentric layer 104 and second concentric layer 102 of conduit 100. In certain examples, a thickness of first concentric layer 104 may be at least 10% of a combined thickness of first concentric layer 104 and second concentric layer 102 of conduit 100. In other examples, a thickness of first concentric layer 104 may be at least 20% of a combined thickness of first concentric layer 104 and second concentric layer 102 of conduit 100. In still other examples, a thickness of first concentric layer 104 may be at least 30% of a combined thickness of first concentric layer 104 and second concentric layer 102 of conduit 100.

In certain examples, the melt viscosity of first concentric layer 104 may be at least ten times higher than the melt viscosity of second concentric layer 102.

In an example, as shown in FIGS. 1A and 1B, second concentric layer 102 is in direct contact with first concentric layer 104. In other examples, as shown in FIGS. 1A and 1B, there is no tie layer between second concentric layer 102 and first concentric layer 104.

In certain examples, first concentric layer 104 may include a polyamide (“PA”), polyvinyl chloride (“PVC”), polybutylene terephthalate (“PBT”), polyethylene terephthalate (“PET”), polystyrene (“PS”), polypropylene (“PP”), polyvinylidene fluoride (“PVDF”), polytetrafluoroethylene (“PTFE”), polyethylene oxide (“PEO”), high-density polyethylene (“HDPE”), or combinations thereof. In a preferred example, first concentric layer 104 may include HDPE. In another preferred example, first concentric layer 104 may include PP.

In other examples, first concentric layer 104 may include a polyamide including PA6 (“Nylon-6,” “polycaprolactam”), PA11 (“Nylon-11”), PA12 (“Nylon-12”), PA46 (“Nylon 46”). PA66 (“Nylon 6/6”), or combinations thereof. In another preferred example, first concentric layer 104 may include PA12.

In certain examples, second concentric layer 102 may include thermoplastic polyurethane (“TPU”), thermoplastic elastomer (“TPE”), poly-2,6-dimethylphenylene oxide (“PPO”), polyvinyl methyl ether, polyvinyl chloride (PVC), polyetherimide (“PEI”), polymethyl methacrylate (“PMMA”), polyacrylic acid (PAA), polyether ketone, or combinations thereof. In a preferred example, second concentric layer 102 may include TPU. In another preferred example, second concentric layer 102 may include TPE.

Thermoplastic polyurethane (TPU) has a high tensile strength to sustain tensile loads during installation, as well as excellent abrasion resistance suitable for HDD trenchless applications. TPU also offers significant cold impact resistance at temperatures of up to −40° C., which is observed in many parts of North America, Europe, and Asia during water. However, at the process temperature of 204° C., as compared to typical pipe extrusion resin like high-density polyethylene (HDPE) that has a melt viscosity of 1440 Pas at a shear rate of 100 s⁻¹, TPU has a melt viscosity of 178 Pas at the same shear rate, which is significantly lower. The low melt viscosity of TPU may make the TPU sag and may make processing the TPU more difficult. Unlike a material like HDPE, in which the molecular weight may control both viscosity and mechanical properties, the mechanical properties of TPU may be controlled by the relative amounts of soft and hard segments of the TPU without largely changing the molecular weight of the TPU. Accordingly, a particular grade of TPU may have desirable mechanical properties, but may not meet the suitable melt strength for pipe extrusion to provide a product in-specification at a desirable production rate.

However, conduit 100 may be a dimensionally in-specification product. Conduit 100 may be produced by utilizing a 2-layer co-extrusion process such that first concentric layer 104 includes a polymer having a higher melt viscosity so as to provide stabilization to second concentric layer 102.

In certain examples, a conduit 100 may be categorized by its standard dimensional ratio (“SDR”), which may refer to the ratio of the outer diameter of conduit 100 to the minimum combined thickness of first concentric layer 104 and second concentric layer 102, as specified in ASTM F2160. In other examples, conduit 100 may have an outer diameter of from greater than about 25 mm, or from about 30 mm, or from about 35 mm, or from about 40 mm, or from about 45 mm, or from about 50 mm, or from about 55 mm, or from about 60 mm, or from about 65 mm, or from about 70 mm, or from about 75 mm, or from about 80 mm, or from about 85 mm, or from about 90 mm, or from about 95 mm, or from about 100 mm, or from about 105 mm, or from about 110 mm, or from about 115, or from about 120 mm, or from about 125 mm, or from about 130 mm, or from about 135 mm, or from about 140 mm, or from about 145 mm, or from about 150 mm, or from about 155 mm, or from about 160 mm, or from about 165 mm, or from about 170 mm, or from about 175 mm, or from about 180 mm, or from about 185 mm, or from about 190 mm, or from about 195 mm, or from about 200 mm, or from about 205 mm, or from about 210 mm, or from about 215 mm, or from about 220 mm, or from about 225 mm, or from about 230 mm, or from about 235 mm, or from about 240 mm, or from about 245 mm, or from about 250 mm, or from about 255 mm, or from about 260 mm, or from about 265 mm, or from about 270 mm, or from about 275 mm, or from about 280 mm, or from about 285 mm, or from about 290 mm, or from about 295 mm, or from about 300 mm, or from about 305 mm, or from about 310 mm, or from about 315 mm, or from about 320 mm to about 323 mm; or from greater than about 25 mm to about 30 mm, or to about 35 mm, or to about 40 mm, or to about 45 mm, or to about 50 mm, or to about 55 mm, or to about 60 mm, or to about 65 mm, or to about 70 mm, or to about 75 mm, or to about 80 mm, or to about 85 mm, or to about 90 mm, or to about 95 mm, or to about 100 mm, or to about 105 mm, or to about 110 mm, or to about 115 mm, or to about 120 mm, or to about 125 mm, or to about 130 mm, or to about 135 mm, or to about 140 mm, or to about 145 mm, or to about 150 mm, or to about 155 mm, or to about 160 mm, or to about 165 mm, or to about 170 mm, or to about 175 mm, or to about 180 mm, or to about 185 mm, or to about 190 mm, or to about 195 mm, or to about 200 mm, or to about 205 mm, or to about 210 mm, or to about 215 mm, or to about 220 mm, or to about 225 mm, or to about 230 mm, or to about 235 mm, or to about 240 mm, or to about 245 mm, or to about 250 mm, or to about 255 mm, or to about 260 mm, or to about 265 mm, or to about 270 mm, or to about 275 mm, or to about 280 mm, or to about 285 mm, or to about 290 mm, or to about 295 mm, or to about 300 mm, or to about 305 mm, or to about 310 mm, or to about 315 mm, or to about 320 mm, or from any one of the above minima to any one of the above maxima.

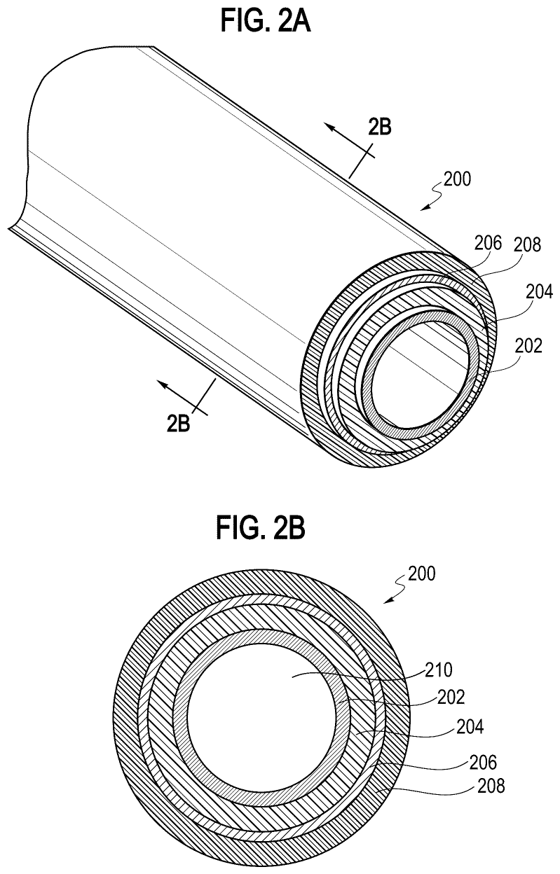

Referring to FIG. 2A, a perspective view of an example of a conduit 200 is illustrated. Conduit 200 includes a first concentric layer 202. First concentric layer 202 includes a first outer surface and defines a lumen 210 extending through first concentric layer 202. Second concentric layer 204 at least partially envelops the first outer surface. First concentric layer 202 and second concentric layer 204 may be coextruded. A melt viscosity of first concentric layer 202 may be higher than a melt viscosity of second concentric layer 204. A thickness of first concentric layer 202 is at least 3% of a combined thickness of first concentric layer 202 and second concentric layer 204 of conduit 200. In certain examples, a thickness of first concentric layer 202 may be at least 10% of a combined thickness of first concentric layer 202 and second concentric layer 204 of conduit 200. In other examples, a thickness of first concentric layer 202 may be at least 20% of a combined thickness of first concentric layer 202 and second concentric layer 204 of conduit 200. In still other examples, a thickness of first concentric layer 202 may be at least 30% of a combined thickness of first concentric layer 202 and second concentric layer 204 of conduit 200.

In certain examples, the melt viscosity of first concentric layer 202 may be at least ten times higher than the melt viscosity of second concentric layer 204.

In an example, as shown in FIGS. 2A and 2B, second concentric layer 204 is in direct contact with first concentric layer 202. In other examples, as shown in FIGS. 2A and 2B, there is no tie layer between second concentric layer 204 and first concentric layer 202.

Third concentric layer 206 includes a third outer surface and at least partially overlaps a second outer surface of second concentric layer 204. Fourth concentric layer 208 at least partially envelops third concentric layer 206. Third concentric layer 206 and fourth concentric layer 208 may be coextruded. A melt viscosity of third concentric layer 206 may be higher than a melt viscosity of fourth concentric layer 208. A combined two-layer thickness of first concentric layer 202 and third concentric layer 206 may be at least 3% of a combined four-layer thickness of first concentric layer 202, second concentric layer 204, third concentric layer 206, and fourth concentric layer 208 of conduit 200. In certain examples, the combined two-layer thickness of first concentric layer 202 and third concentric layer 206 may be at least 10% of the combined four-layer thickness of first concentric layer 202, second concentric layer 204, third concentric layer 206, and fourth concentric layer 208 of conduit 200. In other examples, the combined two-layer thickness of first concentric layer 202 and third concentric layer 206 may be at least 20% of the combined four-layer thickness of first concentric layer 202, second concentric layer 204, third concentric layer 206, and fourth concentric layer 208 of conduit 200. In still other examples, the combined two-layer thickness of first concentric layer 202 and third concentric layer 206 may be at least 30% of the combined four-layer thickness of first concentric layer 202, second concentric layer 204, third concentric layer 206, and fourth concentric layer 208 of conduit 200.

In certain examples, the melt viscosity of third concentric layer 206 may be at least ten times higher than the melt viscosity of fourth concentric layer 208.

In an example, as shown in FIGS. 2A and 2B, second concentric layer 204 is in direct contact with third concentric layer 206, and third concentric layer 206 is in direct contact with fourth concentric layer 208. In other examples, as shown in FIGS. 2A and 2B, there is no tie layer between second concentric layer 204 and third concentric layer 206 and/or no tie layer between third concentric layer 206 and fourth concentric layer 208.

In certain examples, first concentric layer 202 may include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof. In a preferred example, first concentric layer 202 may include HDPE. In another preferred example, first concentric layer 202 may include PP.

In other examples, first concentric layer 202 may include a polyamide including PA6, PA11, PA12, PA46, PA66, or combinations thereof. In another preferred example, first concentric layer 202 may include PA12.

In certain examples, second concentric layer 204 may include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof. In a preferred example, second concentric layer 204 may include TPU. In another preferred example, second concentric layer 204 may include TPE.

In certain examples, third concentric layer 206 may include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof. In a preferred example, third concentric layer 206 may include HDPE. In another preferred example, third concentric layer 206 may include PP.

In other examples, third concentric layer 206 may include a polyamide including PA6, PA11, PA12, PA46, PA66, or combinations thereof. In another preferred example, third concentric layer 206 may include PA12.

In certain examples, fourth concentric layer 208 may include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof. In a preferred example, fourth concentric layer 208 may include TPU. In another preferred example, fourth concentric layer 208 may include TPE.

In certain examples, a conduit 200 may be categorized by its standard dimensional ratio (“SDR”), which may refer to the ratio of the outer diameter of conduit 200 to the minimum combined four-layer thickness of first concentric layer 202, second concentric layer 204, third concentric layer 206, and fourth concentric layer 208, as specified in ASTM F2160. In other examples, conduit 200 may have an outer diameter of from greater than about 25 mm, or from about 30 mm, or from about 35 mm, or from about 40 mm, or from about 45 mm, or from about 50 mm, or from about 55 mm, or from about 60 mm, or from about 65 mm, or from about 70 mm, or from about 75 mm, or from about 80 mm, or from about 85 mm, or from about 90 mm, or from about 95 mm, or from about 100 mm, or from about 105 mm, or from about 110 mm, or from about 115, or from about 120 mm, or from about 125 mm, or from about 130 mm, or from about 135 mm, or from about 140 mm, or from about 145 mm, or from about 150 mm, or from about 155 mm, or from about 160 mm, or from about 165 mm, or from about 170 mm, or from about 175 mm, or from about 180 mm, or from about 185 mm, or from about 190 mm, or from about 195 mm, or from about 200 mm, or from about 205 mm, or from about 210 mm, or from about 215 mm, or from about 220 mm, or from about 225 mm, or from about 230 mm, or from about 235 mm, or from about 240 mm, or from about 245 mm, or from about 250 mm, or from about 255 mm, or from about 260 mm, or from about 265 mm, or from about 270 mm, or from about 275 mm, or from about 280 mm, or from about 285 mm, or from about 290 mm, or from about 295 mm, or from about 300 mm, or from about 305 mm, or from about 310 mm, or from about 315 mm, or from about 320 mm to about 323 mm; or from greater than about 25 mm to about 30 mm, or to about 35 mm, or to about 40 mm, or to about 45 mm, or to about 50 mm, or to about 55 mm, or to about 60 mm, or to about 65 mm, or to about 70 mm, or to about 75 mm, or to about 80 mm, or to about 85 mm, or to about 90 mm, or to about 95 mm, or to about 100 mm, or to about 105 mm, or to about 110 mm, or to about 115 mm, or to about 120 mm, or to about 125 mm, or to about 130 mm, or to about 135 mm, or to about 140 mm, or to about 145 mm, or to about 150 mm, or to about 155 mm, or to about 160 mm, or to about 165 mm, or to about 170 mm, or to about 175 mm, or to about 180 mm, or to about 185 mm, or to about 190 mm, or to about 195 mm, or to about 200 mm, or to about 205 mm, or to about 210 mm, or to about 215 mm, or to about 220 mm, or to about 225 mm, or to about 230 mm, or to about 235 mm, or to about 240 mm, or to about 245 mm, or to about 250 mm, or to about 255 mm, or to about 260 mm, or to about 265 mm, or to about 270 mm, or to about 275 mm, or to about 280 mm, or to about 285 mm, or to about 290 mm, or to about 295 mm, or to about 300 mm, or to about 305 mm, or to about 310 mm, or to about 315 mm, or to about 320 mm, or from any one of the above minima to any one of the above maxima.

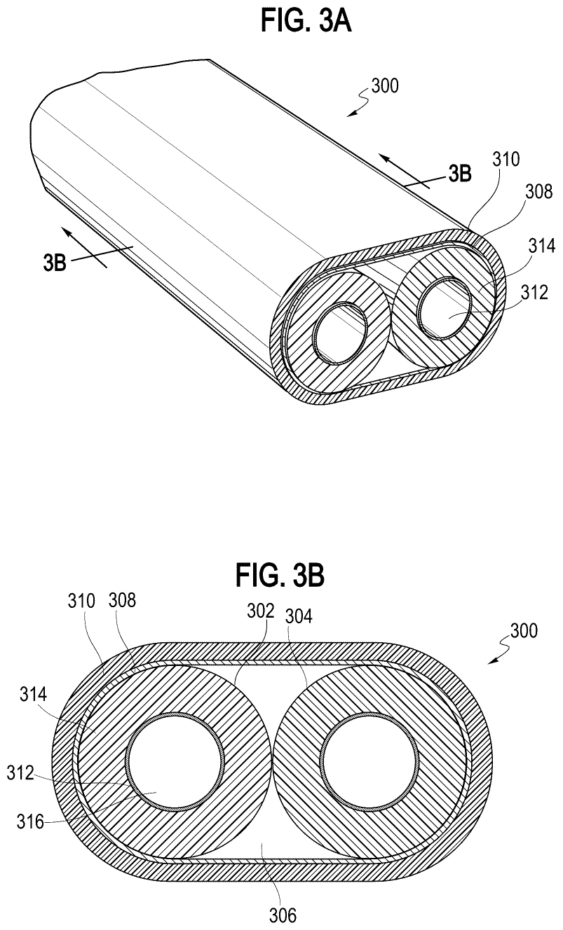

Referring to FIG. 3A, a perspective view of an example of a conduit 300, including microducts 302, 304 in lumen 306, is illustrated. An example of conduit 300 may be referred to as “FuturePath.” Conduit 300 includes a first concentric layer 308. First concentric layer 308 includes a first outer surface and defines lumen 306 extending through first concentric layer 308. Second concentric layer 310 at least partially envelops the first outer surface. First concentric layer 308 and second concentric layer 310 may be coextruded. A melt viscosity of first concentric layer 308 may be higher than a melt viscosity of second concentric layer 310. A thickness of first concentric layer 308 is at least 3% of a combined thickness of first concentric layer 308 and second concentric layer 310 of conduit 300.

In an example, a combined thickness of first concentric layer 308 and second concentric layer 310 of conduit 300 may be from about 0.5 mm, or from about 0.6 mm, or from about 0.7 mm, or from about 0.8 mm, or from about 0.9 mm, or from about 1.0 mm, or from about 1.1 mm, or from about 1.2 mm, or from about 1.3 mm, or from about 1.4 mm, or from about 1.5 mm, or from about 1.6 mm, or from about 1.7 mm, or from about 1.8 mm, or from about 1.9 mm, or from about 2.0 mm, or from about 2.1 mm, or from about 2.2 mm, or from about 2.3 mm, or from about 2.4 mm, or from about 2.5 mm, or from about 2.6 mm, or from about 2.7 mm, or from about 2.8 mm, or from about 2.9 mm, to about 3.0 mm; or from about 0.5 mm to about 0.6 mm, or to about 0.7 mm, or to about 0.8 mm, or to about 0.9 mm, or to about 1.0 mm, or to about 1.1 mm, or to about 1.2 mm, or to about 1.3 mm, or to about 1.4 mm, or to about 1.5 mm, or to about 1.6 mm, or to about 1.7 mm, or to about 1.8 mm, or to about 1.9 mm, or to about 2.0 mm, or to about 2.1 mm, or to about 2.2 mm, or to about 2.3 mm, or to about 2.4 mm, or to about 2.5 mm, or to about 2.6 mm, or to about 2.7 mm, or to about 2.8 mm, or to about 2.9 mm; or from any one of the above minima to any one of the above maxima.

In certain examples, a thickness of first concentric layer 308 may be at least 10% of a combined thickness of first concentric layer 308 and second concentric layer 310 of conduit 300. In other examples, a thickness of first concentric layer 308 may be at least 20% of a combined thickness of first concentric layer 308 and second concentric layer 310 of conduit 300. In still other examples, a thickness of first concentric layer 308 may be at least 30% of a combined thickness of first concentric layer 308 and second concentric layer 310 of conduit 300.

In certain examples, the melt viscosity of first concentric layer 308 may be at least ten times higher than the melt viscosity of second concentric layer 310.

In an example, as shown in FIGS. 3A and 3B, second concentric layer 310 is in direct contact with first concentric layer 308. In other examples, as shown in FIGS. 3A and 3B, there is no tie layer between second concentric layer 310 and first concentric layer 308.

Conduit 300 includes microducts 302, 304 extending through lumen 306. Each of microducts 302, 304 includes inner microduct concentric layer 312. Inner microduct concentric layer 312 includes an inner microduct outer surface, and a microduct lumen 316 extending through inner microduct concentric layer 312. Outer microduct concentric layer 314 at least partially envelops the inner microduct outer surface. Inner microduct concentric layer 312 and outer microduct concentric layer 314 may be coextruded. A melt viscosity of inner microduct concentric layer 312 may be higher than a melt viscosity of outer microduct concentric layer 314. An inner microduct thickness of inner microduct concentric layer 312 is at least 3% of a combined thickness of inner microduct concentric layer 312 and outer microduct concentric layer 314. In certain examples, an inner microduct thickness of inner microduct concentric layer 312 may be at least 10% of a combined thickness of inner microduct concentric layer 312 and outer microduct concentric layer 314. In other examples, an inner microduct thickness of inner microduct concentric layer 312 may be at least 20% of a combined thickness of inner microduct concentric layer 312 and outer microduct concentric layer 314. In still other examples, an inner microduct thickness of inner microduct concentric layer 312 may be at least 30% of a combined thickness of inner microduct concentric layer 312 and outer microduct concentric layer 314.

In an example, microducts 302, 304 may each have an inner diameter of from about 3 mm, or from about 3.5 mm, or from about 4.0 mm, or from about 4.5 mm, or from about 5.0 mm, or from about 5.5 mm, or from about 6.0 mm, or from about 6.5 mm, or from about 7.0 mm, or from about 7.5 mm, or from about 8.0 mm, or from about 8.5 mm, or from about 9.0 mm, or from about 9.5 mm, or from about 10.0 mm, or from about 10.5 mm, or from about 11.0 mm, or from about 11.5 mm, or from about 12.0 mm, or from about 12.5 mm, or from about 13.0 mm, or from about 13.5 mm, or from about 14.0 mm, or from about 14.5 mm, or from about 15.0 mm, or from about 15.5 mm, or from about 16.0 mm, or from about 16.5 mm, or from about 17.0 mm, or from about 17.5 mm, or from about 18.0 mm, or from about 18.5 mm, or from about 19.0 mm, or from about 19.5 mm, or from about 20.0 mm; or from about 3.5 mm to about 4.0 mm, or to about 4.5 mm, or to about 5.0 mm, or to about 5.5 mm, or to about 6.0 mm, or to about 6.5 mm, or to about 7.0 mm, or to about 7.5 mm, or to about 8.0 mm, or to about 8.5 mm, or to about 9.0 mm, or to about 9.5 mm, or to about 10.0 mm, or to about 10.5 mm, or to about 11.0 mm, or to about 11.5 mm, or to about 12.0 mm, or to about 12.5 mm, or to about 13.0 mm, or to about 13.5 mm, or to about 14.0 mm, or to about 14.5 mm, or to about 15.0 mm, or to about 15.5 mm, or to about 16.0 mm, or to about 16.5 mm, or to about 17.0 mm, or to about 17.5 mm, or to about 18.0 mm, or to about 18.5 mm, or to about 19.0 mm, or to about 19.5 mm, or from any one of the above minima to any one of the above maxima.

In an example, microducts 302, 304 may each have an outer diameter greater than the inner diameter. In an example, the outer diameter of each of microducts 302, 304 may be from about 5.0 mm, or from about 5.5 mm, or from about 6.0 mm, or from about 6.5 mm, or from about 7.0 mm, or from about 7.5 mm, or from about 8.0 mm, or from about 8.5 mm, or from about 9.0 mm, or from about 9.5 mm, or from about 10.0 mm, or from about 10.5 mm, or from about 11.0 mm, or from about 11.5 mm, or from about 12.0 mm, or from about 12.5 mm, or from about 13.0 mm, or from about 13.5 mm, or from about 14.0 mm, or from about 14.5 mm, or from about 15.0 mm, or from about 15.5 mm, or from about 16.0 mm, or from about 16.5 mm, or from about 17.0 mm, or from about 17.5 mm, or from about 18.0 mm, or from about 18.5 mm, or from about 19.0 mm, or from about 19.5 mm, or from about 20.0 mm, or from about 20.5 mm, or from about 21.0 mm, or from about 21.5 mm, or from about 22.0 mm, or from about 22.5 mm, or from about 23.0 mm, or from about 23.5 mm, or from about 24.0 mm, or from about 24.5 mm to about 25.0 mm; or from about 5.0 mm to about 5.5 mm, or to about 6.0 mm, or to about 6.5 mm, or to about 7.0 mm, or to about 7.5 mm, or to about 8.0 mm, or to about 8.5 mm, or to about 9.0 mm, or to about 9.5 mm, or to about 10.0 mm, or to about 10.5 mm, or to about 11.0 mm, or to about 11.5 mm, or to about 12.0 mm, or to about 12.5 mm, or to about 13.0 mm, or to about 13.5 mm, or to about 14.0 mm, or to about 14.5 mm, or to about 15.0 mm, or to about 15.5 mm, or to about 16.0 mm, or to about 16.5 mm, or to about 17.0 mm, or to about 17.5 mm, or to about 18.0 mm, or to about 18.5 mm, or to about 19.0 mm, or to about 19.5 mm, or to about 20.0 mm, or to about 20.5 mm, or to about 21.0 mm, or to about 21.5 mm, or to about 22.0 mm, or to about 22.5 mm, or to about 23.0 mm, or to about 23.5 mm, or to about 24.0 mm, or to about 24.5 mm; or from any one of the above minima to any one of the above maxima.

Though not shown in FIGS. 3A and 3B, conduit 300 may include at least one cable disposed in microduct lumen 316. The at least one cable may be selected from the group consisting of communications cable, power cable, and combinations thereof.

In certain examples, the melt viscosity of inner microduct concentric layer 312 may be at least ten times higher than the melt viscosity of outer microduct concentric layer 314.

In an example, as shown in FIGS. 3A and 3B, outer microduct concentric layer 314 is in direct contact with inner microduct concentric layer 312. In other examples, as shown in FIGS. 3A and 3B, there is no tie layer between outer microduct concentric layer 314 and inner microduct concentric layer 312.

In certain examples, first concentric layer 308 may include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof. In a preferred example, first concentric layer 308 may include HDPE. In another preferred example, first concentric layer 308 may include PP.

In other examples, first concentric layer 308 may include a polyamide including PA6, PA11, PA12, PA46, PA66, or combinations thereof. In another preferred example, first concentric layer 308 may include PA12.

In certain examples, second concentric layer 310 may include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof. In a preferred example, second concentric layer 310 may include TPU. In another preferred example, second concentric layer 310 may include TPE.

In certain examples, inner microduct concentric layer 312 may include a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof. In a preferred example, inner microduct concentric layer 312 may include HDPE. In another preferred example, inner microduct concentric layer 312 may include PP.

In other examples, inner microduct concentric layer 312 may include a polyamide including PA6, PA11, PA12, PA46, PA66, or combinations thereof. In another preferred example, inner microduct concentric layer 312 may include PA12.

In certain examples, outer microduct concentric layer 314 may include thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof. In a preferred example, outer microduct concentric layer 314 may include TPU. In another preferred example, outer microduct concentric layer 314 may include TPE.

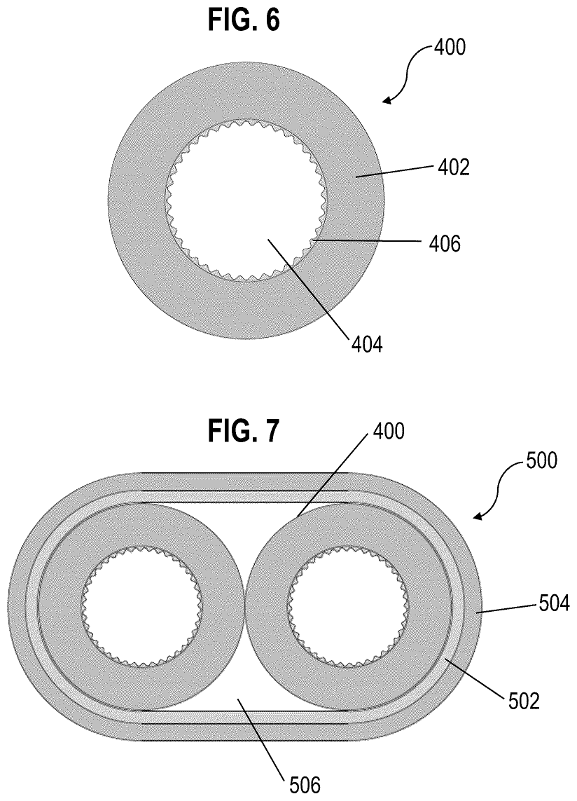

Referring to FIG. 6, another example of a microduct 400 is illustrated. Microduct lumen 404 extends longitudinally through inner microduct concentric layer 402. A plurality of ribs 406 extends longitudinally along an inner surface of inner microduct concentric layer 402. Each of the plurality of ribs 406 protrudes inward toward microduct lumen 404. Plurality of ribs 406 is configured to minimize the coefficient of friction of a cable (not shown) pulled longitudinally through microduct lumen 404. Plurality of ribs 406 may be evenly distributed about a circumference of microduct lumen 404. Plurality of ribs 406 may be integral to inner microduct concentric layer 402 and include the polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof, of inner microduct concentric layer 402. Plurality of ribs 406 may include, for example, at least two ribs 406 evenly distributed (separated by 180°) about the circumference of microduct lumen 404, or at least 4 ribs 406 evenly distributed (separated by 90°) about the circumference of microduct lumen 404, or at least six ribs 406 evenly distributed (separated by 60°) about the circumference of microduct lumen 404, or at least eight ribs 406 evenly distributed (separated by 45°) about the circumference of microduct lumen 404, or more ribs 406 evenly distributed about the circumference of microduct lumen 404. As illustrated in FIG. 6, the plurality of ribs 406 includes 42 ribs evenly distributed about the circumference of microduct lumen 404, separated by about 8.6°.

Referring to FIG. 7, a cross-sectional view of another example of a conduit 500 is illustrated. Conduit 500 includes first concentric layer 502 and second concentric layer 504. Second concentric layer 504 at least partially envelops first concentric layer 502. First concentric layer 502 and second concentric layer 504 may be in direct contact or may be without a tie layer between first concentric layer 502 and second concentric layer 504. First concentric layer 504 defines lumen 506 extending longitudinally through first concentric layer 504. Conduit 500 may include at least one microduct 400 within lumen 506.

The conduits and methods described above may be better understood in connection with the following Examples. In addition, the following non-limiting examples are an illustration. The illustrated methods are applicable to other examples of conducts of the present disclosure. The procedures described as general methods describe what is believed will be typically effective to provide conduits of the present disclosure. However, the person skilled in the art will appreciate that it may be necessary to vary the procedures for any given example of the present disclosure, e.g., vary the order or steps and/or the chemical reagents used.

### EXAMPLES

### 1. Preparation of Example of Conduit with Microducts

An example of a conduit that is illustrated in FIGS. 3A and 3B was produced by a 2-layer co-extrusion process operating at about 216° C., including a polyamide (PA12) with a high melt viscosity as first concentric layer 308 and inner microduct concentric layer 312, and TPU as second concentric layer 310 and outer microduct concentric layer 314. The polyamide used is commercially available under the tradename and grade Vestamid® NRG 3001, from the supplier Evonik Industries. The TPU used is commercially available under the tradename and grade Estane ETE 65DT3, from the supplier Lubrizol. The TPU layers 310 and 314 had a thickness of 1.8 mm and 3.5 mm, respectively. The polyamide layers 308 and 312 had a thickness of 0.8 mm and 0.8 mm, respectively. The microducts 302, 304 had an outside diameter of 18 mm.

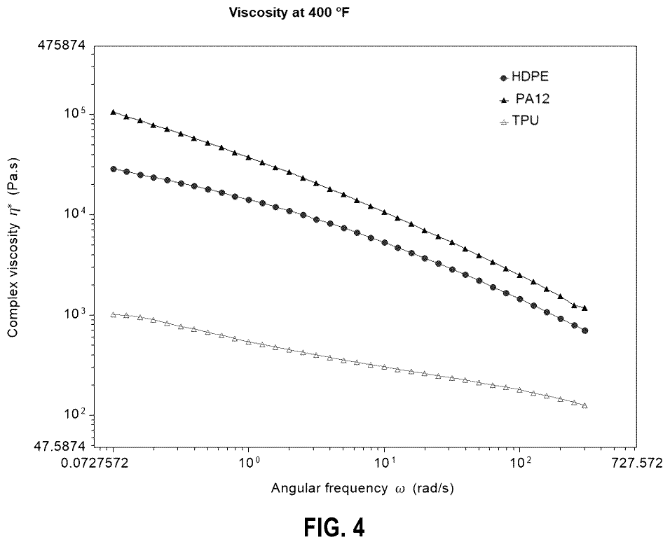

FIG. 4 illustrates a comparison of the viscosity-oscillation frequency data for PA12 to the viscosity-oscillation frequency data for pipe-grade HDPE resin and TPU functional material. The pipe grade HDPE resin is commercially available under the tradename and grade Alathon L5040TC, from the supplier Lyondellbasell. As FIG. 4 demonstrates, the “complex viscosity,” also known as melt viscosity, of PA12 is twice the melt viscosity of HDPE and over 10 times the melt viscosity of TPU. The large melt viscosity of PA12 may stabilize the TPU if the co-extruded layer of PA12 is present in as little as 3% of the combined thickness of the two concentric layers of conduit, or as little as 3% of the combined thickness of the two concentric layers of microduct.

### 2. Determination of Properties of Coextruded Conduit of Example 1, Illustrated in FIGS. 3A and 3B

The functional properties of the PA12/TPU co-extruded conduit of Example 1 were tested and compared to a conduit prepared from HDPE.

### A. Safe Pull Load.

The minimum working pull strength of the conduit and microducts was determined in accordance with the applicable provisions of ASTM D 638 and modifications specified in GR-356-CORE Performance Requirements and Test Procedures Issue 2, June. 2009 4-10 Telecordia Technologies, Inc. Five test specimens were used for each sample tested. Each test specimen measured 12 inches±⅛ inch long (300 mm±3 mm) and was cut from the respective sample. The Zwick/Roell Z050 N universal tensile machines was used, and the rate of testing was 2.0 in/min (5.1 cm/min).

### B. Crush Load at 20% Deflection.

Crush load measurements were conducted following ASTM D2412, using a Zwick/Roell Z050N universal tensile machine. For each sample, 5 test specimens were used, each test specimen measured 6 inches±⅛ inch long (150 mm±3 mm). Test specimens were tested at a compressive deformation rate of 0.5 in/min (12.5 mm/min). From the crush load deformation graph, the crush load at 20% deformation was recorded.

### C. Abrasion Mass Loss.

The abrasion mass loss was measured using a test method based on the ASTM D3389. In this test, for each sample, a specimen of 6 inches±⅛ inch long (150 mm+3 mm) was used. The specimen was abraded over a 50-grit abrasive cloth with a 15-lb (6.8 kg) force for 2 hours. The specimen was weighed before and after the abrasion. The weight loss after the abrasion was calculated as a percentage of the original weight.

Table 1 lists the functional properties of the coextruded conduit of Example 1 compared to a similar product made from HDPE. The coextruded conduit of Example 1 has a safe pull load that is about 3 times the safe pull load of the comparison product made from HDPE. Further, the coextruded conduit of Example 1 has a 6% greater crush load at 20% deflection, and about twice the abrasion mass loss, of the comparison product made from HDPE.

TABLE 1

| | | |
|---|---|---|
| | Coextruded Conduit | HDPE Comparison |
| Property | of Example 1 | Product |

| | | | | |
|---|---|---|---|---|
| Safe Pull Load | 2685 | kgf | 935 | kgf |
| Crush Load at 20% | 7399 | lbf | 6951 | lbf |
| Deflection | | | | |

| | | |
|---|---|---|
| Abrasion Mass Loss | 0.14% | 0.27% |

### 3. Crush Force-Deformation Dependence on Relative Layer Thicknesses

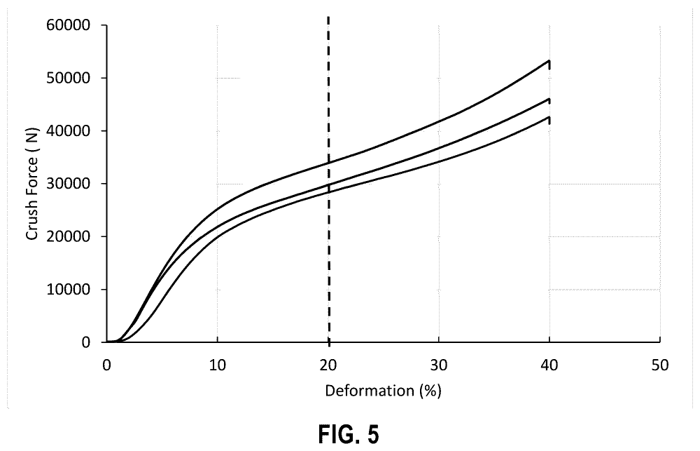

A coextruded conduit product of the present disclosure may have mechanical integrity if there is chemical compatibility between the coextruded materials such that the coextruded materials may form a unified load transfer body. If coextruded materials are not compatible, the layer with a higher melt viscosity may simply act as a scaffold and may not contribute to the loading capability of the conduit. FIG. 5 illustrates a crush force-deformation plot for an example of a conduit that is illustrated in FIGS. 3A and 3B and prepared according to Example 1, produced by a 2-layer co-extrusion process, including a polyamide (PA12) with a high melt viscosity as first concentric layer 308, and TPU as second concentric layer 310, as well as another example of a PA12-TPU conduit with different PA12 and TPU layer thicknesses. FIG. 5 demonstrates crush force-deformation of two examples of the PA12-TPU conduits with different PA12 and TPU layer thicknesses compared to a conduit made from HDPE. For a telecommunication industry standard deformation of 20%, the crush force for a coextruded conduit including 30% PA12 and 70% TPU is 7399 lbf prepared according to Example 1 (top curve illustrated in FIG. 5, percentages reflect the layer thicknesses for the co-extruded conduits), which is 6% greater than that of single-layer HDPE (middle curve illustrated in FIG. 5). The crush force for a coextruded conduit including 20% PA12 and 80% TPU (bottom curve illustrated in FIG. 5, percentages reflect the layer thicknesses for the co-extruded conduits) is 7% smaller than that of HDPE. Because PA12 and TPU are chemically compatible, by varying the relative layer thicknesses, the crush force of the coextruded conduit may be controlled. The crush force-deformation results demonstrate the importance of compatibility between layers of a coextruded conduit. If the layers of a coextruded conduit include chemically compatible materials, a synergistic impact on both processing and product properties is observed that is dependent on the relative percentages of the coextruded layers of the individual materials. When PA12 and TPU are coextruded at a layer thickness of PA12 of less than 10%, it was observed that PA12 provides mostly process stabilization of TPU. When PA12 has a relative layer thickness of greater than 10%, the PA12 provides both processing stabilization and mechanical functionality to the coextruded product, as illustrated in FIG. 5.

Although the present disclosure has been described with reference to examples and the accompanying drawings, the present disclosure is not limited thereto, but may be variously modified and altered by those skilled in the art to which the present disclosure pertains without departing from the spirit and scope of the present disclosure.

The subject-matter of the disclosure may also relate, among others, to the following aspects:

A first aspect relates to a conduit, comprising: a first concentric layer, comprising a first outer surface and defining a lumen extending therethrough; a second concentric layer at least partially enveloping the first outer surface; wherein the first concentric layer and the second concentric layer are coextruded; wherein a first melt viscosity of the first concentric layer is higher than a second melt viscosity of the second concentric layer; and wherein a thickness of the first concentric layer is at least 3% of a combined thickness of the first and second concentric layers of the conduit.

A second aspect relates to the conduit of aspect 1, wherein the first melt viscosity is at least ten times higher than the second melt viscosity.

A third aspect relates to the conduit of any preceding aspect, wherein the first concentric layer comprises a polyamide (“PA”), polyvinyl chloride (“PVC”), polybutylene terephthalate (“PBT”), polyethylene terephthalate (“PET”), polystyrene (“PS”), polypropylene (“PP”), polyvinylidene fluoride (“PVDF”), polytetrafluoroethylene (“PTFE”), polyethylene oxide (“PEO”), high-density polyethylene (“HDPE”), or combinations thereof.

A fourth aspect relates to the conduit of any preceding aspect, wherein the first concentric layer comprises a polyamide comprising PA6, PA11, PA12, PA46, PA66, or combinations thereof.

A fifth aspect relates to the conduit of any preceding aspect, wherein the second concentric layer comprises thermoplastic polyurethane (“TPU”), thermoplastic elastomer (“TPE”), poly-2,6-dimethylphenylene oxide (“PPO”), polyvinyl methyl ether, polyvinyl chloride (“PVC”), polyetherimide (“PEI”), polymethyl methacrylate (“PMMA”), polyacrylic acid (“PAA”), polyether ketone, or combinations thereof.

A sixth aspect relates to the conduit of any preceding aspect, wherein the first concentric layer comprises PA12 and the second concentric layer comprises TPU.

A seventh aspect relates to the conduit of aspects 1 to 5, wherein the first concentric layer comprises HDPE and the second concentric layer comprises TPU.

An eighth aspect relates to the conduit of aspects 1 to 5, wherein the first concentric layer comprises PP and the second concentric layer comprises TPE.

A ninth aspect relates to the conduit of any preceding aspect, wherein the thickness of the first concentric layer is at least 10% of the combined thickness.

A tenth aspect relates to the conduit of any preceding aspect, wherein the thickness of the first concentric layer is at least 20% of the combined thickness.

An eleventh aspect relates to the conduit of any preceding aspect, wherein the thickness of the first concentric layer is at least 30% of the combined thickness.

A twelfth aspect relates to the conduit of any preceding aspect, wherein the second concentric layer is in direct contact with the first concentric layer.

A thirteenth aspect relates to the conduit of aspects 1 to 12, without a tie layer between the first concentric layer and the second concentric layer.

A fourteenth aspect relates to the conduit of any preceding aspect, further comprising: a third concentric layer comprising a third outer surface, the third concentric layer at least partially enveloping a second outer surface of the second concentric layer; and a fourth concentric layer at least partially enveloping the third concentric layer; wherein the third concentric layer and the fourth concentric layer are coextruded; wherein a third melt viscosity of the third concentric layer is higher than a fourth melt viscosity of the fourth concentric layer; and wherein a combined two-layer thickness of the first concentric layer and the third concentric layer is at least 3% of a combined four-layer thickness of the first, second, third, and fourth concentric layers of the conduit.

A fifteenth aspect relates to the conduit of aspect 14, wherein the third melt viscosity is at least ten times higher than the fourth melt viscosity.

A sixteenth aspect relates to the conduit of aspects 14 and 15, wherein the third concentric layer comprises a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof.

A seventeenth aspect relates to the conduit of aspects 14 to 16, wherein the third concentric layer comprises a polyamide comprising PA6, PA11, PA12, PA46, PA66, or combinations thereof.

An eighteenth aspect relates to the conduit of aspects 14 to 17, wherein the fourth concentric layer comprises thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

A nineteenth aspect relates to the conduit of aspects 14 to 18, wherein the third concentric layer comprises PA12 and the fourth concentric layer comprises TPU.

A twentieth aspect relates to the conduit of aspects 14 to 18, wherein the third concentric layer comprises HDPE and the fourth concentric layer comprises TPU.

A twenty-first aspect relates to the conduit of aspects 14 to 18, wherein the third concentric layer comprises PP and the fourth concentric layer comprises TPE.

A twenty-second aspect relates to the conduit of aspects 14 to 21, wherein the combined two-layer thickness is at least 10% of the combined four-layer thickness.

A twenty-third aspect relates to the conduit of aspects 14 to 22, wherein the combined two-layer thickness is at least 20% of the combined four-layer thickness.

A twenty-fourth aspect relates to the conduit of aspects 14 to 23, wherein the combined two-layer thickness is at least 30% of the combined four-layer thickness.

A twenty-fifth aspect relates to the conduit of aspects 14 to 24, wherein the fourth concentric layer is in direct contact with the third concentric layer.

A twenty-sixth aspect relates to the conduit of aspects 14 to 25, wherein the third concentric layer is in direct contact with the second concentric layer.

A twenty-seventh aspect relates to the conduit of aspects 14 to 24, without a tie layer between the third concentric layer and the fourth concentric layer.

A twenty-eighth aspect relates to the conduit of aspects 14 to 24 and 27, without a tie layer between the third concentric layer and the second concentric layer.

A twenty-ninth aspect relates to the conduit of any preceding aspect, further comprising at least one microduct extending through the lumen.

A thirtieth aspect relates to the conduit of aspect 29, wherein the at least one microduct each comprise: an inner microduct concentric layer, comprising an inner microduct outer surface, and a microduct lumen extending therethrough; and an outer microduct concentric layer, the outer microduct concentric layer at least partially enveloping the inner microduct outer surface; wherein the inner microduct concentric layer and the outer microduct concentric layer are coextruded; wherein an inner microduct melt viscosity of the inner microduct concentric layer is higher than an outer microduct melt viscosity of the outer microduct concentric layer; and wherein an inner microduct thickness of the inner microduct concentric layer is at least 3% of a combined microduct thickness of the inner and outer concentric layers of the at least one microduct.

A thirty-first aspect relates to the conduit of aspect 30, further comprising at least one cable disposed in the microduct lumen.

A thirty-second aspect relates to the conduit of aspect 31, wherein the cable is selected from the group consisting of communications cable, power cable, and combinations thereof.

A thirty-third aspect relates to the conduit of aspects 30 to 32, wherein the inner microduct melt viscosity is at least ten times higher than the outer microduct melt viscosity.

A thirty-fourth aspect relates to the conduit of aspects 30 to 33, wherein the inner microduct concentric layer comprises a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof.

A thirty-fifth aspect relates to the conduit of aspects 30 to 34, wherein the inner microduct concentric layer comprises a polyamide comprising PA6, PA11, PA12, PA46, PA66, or combinations thereof.

A thirty-sixth aspect relates to the conduit of aspects 30 to 35, wherein the outer microduct concentric layer comprises thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

A thirty-seventh aspect relates to the conduit of aspects 30 to 36, wherein the inner microduct concentric layer comprises PA12 and the outer microduct concentric layer comprises TPU.

A thirty-eighth aspect relates to the conduit of aspects 30 to 36, wherein the inner microduct concentric layer comprises HDPE and the outer microduct concentric layer comprises TPU.

A thirty-ninth aspect relates to the conduit of aspects 30 to 36, wherein the inner microduct concentric layer comprises PP and the outer microduct concentric layer comprises TPE.

A fortieth aspect relates to the conduit of aspects 30 to 39, wherein the inner microduct thickness is at least 10% of the combined microduct thickness of the inner and outer microduct concentric layers.

A forty-first aspect relates to the conduit of aspects 30 to 40, wherein the inner microduct thickness is at least 20% of the combined microduct thickness of the inner and outer microduct concentric layers.

A forty-second aspect relates to the conduit of aspects 30 to 41, wherein the inner microduct thickness is at least 30% of the combined microduct thickness of the inner and outer microduct concentric layers.

A forty-third aspect relates to the conduit of aspects 30 to 42, wherein the inner microduct concentric layer is in direct contact with the outer microduct concentric layer.

A forty-fourth aspect relates to the conduit of aspects 30 to 42, without a tie layer between the inner microduct concentric layer and the outer microduct concentric layer.

A thirty-ninth aspect relates to an oversheath, comprising: a first concentric layer, comprising a first outer surface and defining a lumen extending therethrough; a second concentric layer at least partially enveloping the first outer surface; and at least one conduit extending through the lumen, the at least one conduit each comprising: an inner conduit concentric layer, comprising a conduit outer surface and a conduit lumen extending therethrough; and an outer conduit concentric layer, the outer conduit concentric layer at least partially enveloping the inner conduit concentric layer; wherein the first concentric layer and the second concentric layer are coextruded; wherein the inner conduit concentric layer and the outer conduit concentric layer are coextruded; wherein a first melt viscosity of the first concentric layer is higher than a second melt viscosity of the second concentric layer; wherein an inner conduit melt viscosity of the inner conduit concentric layer is higher than an outer conduit melt viscosity of the outer conduit concentric layer; wherein a thickness of the first concentric layer is at least 3% of a combined thickness of the first and second concentric layers of the oversheath; wherein an inner conduit thickness of the inner conduit concentric layer is at least 3% of a combined conduit thickness of the inner and outer conduit concentric layers of the at least one conduit; wherein the first concentric layer and the inner conduit concentric layer each independently comprise a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof; and wherein the second concentric layer and the outer concentric layer each independently comprise thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

In addition to the features mentioned in each of the independent aspects enumerated above, some examples may show, alone or in combination, the optional features mentioned in the dependent aspects and/or as disclosed in the description above and shown in the figures.

What is claimed is:

1. A conduit, comprising:
a first concentric layer, comprising a first outer surface and defining a lumen extending therethrough;
a second concentric layer at least partially enveloping the first outer surface;
wherein the first concentric layer and the second concentric layer are coextruded;
wherein a first melt viscosity of the first concentric layer is higher than a second melt viscosity of the second concentric layer; and
wherein a thickness of the first concentric layer is at least 3% of a combined thickness of the first and second concentric layers of the conduit.

2. The conduit of claim 1, wherein the first melt viscosity is at least ten times higher than the second melt viscosity.

3. The conduit of claim 1, wherein the first concentric layer comprises a polyamide (“PA”), polyvinyl chloride (“PVC”), polybutylene terephthalate (“PBT”), polyethylene terephthalate (“PET”), polystyrene (“PS”), polypropylene (“PP”), polyvinylidene fluoride (“PVDF”), polytetrafluoroethylene (“PTFE”), polyethylene oxide (“PEO”), high-density polyethylene (“HDPE”), or combinations thereof.

4. The conduit of claim 1, wherein the first concentric layer comprises a polyamide comprising PA6, PA11, PA12, PA46, PA66, or combinations thereof.

5. The conduit of claim 1, wherein the second concentric layer comprises thermoplastic polyurethane (“TPU”), thermoplastic elastomer (“TPE”), poly-2,6-dimethylphenylene oxide (“PPO”), polyvinyl methyl ether, polyvinyl chloride (“PVC”), polyetherimide (“PEI”), polymethyl methacrylate (“PMMA”), polyacrylic acid (“PAA”), polyether ketone, or combinations thereof.

6. The conduit of claim 1, wherein the first concentric layer comprises PA12 and the second concentric layer comprises TPU.

7. The conduit of claim 1, wherein the first concentric layer comprises HDPE and the second concentric layer comprises TPU.

8. The conduit of claim 1, wherein the first concentric layer comprises PP and the second concentric layer comprises TPE.

9. The conduit of claim 1, wherein the thickness of the first concentric layer is at least 10% of the combined thickness.

10. The conduit of claim 1, wherein the thickness of the first concentric layer is at least 20% of the combined thickness.

11. The conduit of claim 1, wherein the thickness of the first concentric layer is at least 30% of the combined thickness.

12. The conduit of claim 1, wherein the second concentric layer is in direct contact with the first concentric layer.

13. The conduit of claim 1, without a tie layer between the first concentric layer and the second concentric layer.

14. The conduit of claim 1, further comprising:
a third concentric layer comprising a third outer surface, the third concentric layer at least partially enveloping a second outer surface of the second concentric layer; and
a fourth concentric layer at least partially enveloping the third concentric layer;
wherein the third concentric layer and the fourth concentric layer are coextruded;
wherein a third melt viscosity of the third concentric layer is higher than a fourth melt viscosity of the fourth concentric layer; and
wherein a combined two-layer thickness of the first concentric layer and the third concentric layer is at least 3% of a combined four-layer thickness of the first, second, third, and fourth concentric layers of the conduit.

15. The conduit of claim 12, wherein the third melt viscosity is at least ten times higher than the fourth melt viscosity.

16. The conduit of claim 12, wherein the third concentric layer comprises a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof.

17. The conduit of claim 12, wherein the third concentric layer comprises a polyamide comprising PA6, PA11, PA12, PA46, PA66, or combinations thereof.

18. The conduit of claim 12, wherein the fourth concentric layer comprises thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

19. The conduit of claim 12, wherein the third concentric layer comprises PA12 and the fourth concentric layer comprises TPU.

20. The conduit of claim 12, wherein the third concentric layer comprises HDPE and the fourth concentric layer comprises TPU.

21. The conduit of claim 12, wherein the third concentric layer comprises PP and the fourth concentric layer comprises TPE.

22. The conduit of claim 12, wherein the combined two-layer thickness is at least 10% of the combined four-layer thickness.

23. The conduit of claim 12, wherein the combined two-layer thickness is at least 20% of the combined four-layer thickness.

24. The conduit of claim 12, wherein the combined two-layer thickness is at least 30% of the combined four-layer thickness.

25. The conduit of claim 12, wherein the fourth concentric layer is in direct contact with the third concentric layer.

26. The conduit of claim 12, wherein the third concentric layer is in direct contact with the second concentric layer.

27. The conduit of claim 12, without a tie layer between the third concentric layer and the fourth concentric layer.

28. The conduit of claim 12, without a tie layer between the third concentric layer and the second concentric layer.

29. The conduit of claim 1, further comprising at least one microduct extending through the lumen.

30. The conduit of claim 29, wherein the at least one microduct each comprise:
an inner microduct concentric layer, comprising an inner microduct outer surface, and a microduct lumen extending therethrough; and
an outer microduct concentric layer, the outer microduct concentric layer at least partially enveloping the inner microduct outer surface;
wherein the inner microduct concentric layer and the outer microduct concentric layer are coextruded;
wherein an inner microduct melt viscosity of the inner microduct concentric layer is higher than an outer microduct melt viscosity of the outer microduct concentric layer; and
wherein an inner microduct thickness of the inner microduct concentric layer is at least 3% of a combined microduct thickness of the inner and outer concentric layers of the at least one microduct.

31. The conduit of claim 30, further comprising at least one cable disposed in the microduct lumen.

32. The conduit of claim 31, wherein the cable is selected from the group consisting of communications cable, power cable, and combinations thereof.

33. The conduit of claim 30, wherein the inner microduct melt viscosity is at least ten times higher than the outer microduct melt viscosity.

34. The conduit of claim 30, wherein the inner microduct concentric layer comprises a polyamide (PA), polyvinyl chloride (PVC), polybutylene terephthalate (PBT), polyethylene terephthalate (PET), polystyrene (PS), polypropylene (PP), polyvinylidene fluoride (PVDF), polytetrafluoroethylene (PTFE), polyethylene oxide (PEO), high-density polyethylene (HDPE), or combinations thereof.

35. The conduit of claim 30, wherein the inner microduct concentric layer comprises a polyamide comprising PA6, PA11, PA12, PA46, PA66, or combinations thereof.

36. The conduit of claim 30, wherein the outer microduct concentric layer comprises thermoplastic polyurethane (TPU), thermoplastic elastomer (TPE), poly-2,6-dimethylphenylene oxide (PPO), polyvinyl methyl ether, polyvinyl chloride (PVC), polyetherimide (PEI), polymethyl methacrylate (PMMA), polyacrylic acid (PAA), polyether ketone, or combinations thereof.

37. The conduit of claim 30, wherein the inner microduct concentric layer comprises PA12 and the outer microduct concentric layer comprises TPU.

38. The conduit of claim 30, wherein the inner microduct concentric layer comprises HDPE and the outer microduct concentric layer comprises TPU.

39. The conduit of claim 30, wherein the inner microduct concentric layer comprises PP and the outer microduct concentric layer comprises TPE.

40. The conduit of claim 30, wherein the inner microduct thickness is at least 10% of the combined microduct thickness of the inner and outer microduct concentric layers.

41. The conduit of claim 30, wherein the inner microduct thickness is at least 20% of the combined microduct thickness of the inner and outer microduct concentric layers.

42. The conduit of claim 30, wherein the inner microduct thickness is at least 30% of the combined microduct thickness of the inner and outer microduct concentric layers.

43. The conduit of claim 30, wherein the inner microduct concentric layer is in direct contact with the outer microduct concentric layer.

44. The conduit of claim 30, without a tie layer between the inner microduct concentric layer and the outer microduct concentric layer.

45. An oversheath, comprising:
a first concentric layer, comprising a first outer surface and defining a lumen extending therethrough;
a second concentric layer at least partially enveloping the first outer surface; and
at least one conduit extending through the lumen, the at least one conduit each comprising:
an inner conduit concentric layer, comprising a conduit outer surface and a conduit lumen extending therethrough; and
an outer conduit concentric layer, the outer conduit concentric layer at least partially enveloping the inner conduit concentric layer;
wherein the first concentric layer and the second concentric layer are coextruded;
wherein the inner conduit concentric layer and the outer conduit concentric layer are coextruded;
wherein a first melt viscosity of the first concentric layer is higher than a second melt viscosity of the second concentric layer;
wherein an inner conduit melt viscosity of the inner conduit concentric layer is higher than an outer conduit melt viscosity of the outer conduit concentric layer;
wherein a thickness of the first concentric layer is at least 3% of a combined thickness of the first and second concentric layers of the oversheath;
wherein an inner conduit thickness of the inner conduit concentric layer is at least 3% of a combined thickness of the inner and outer conduit concentric layers of the at least one conduit;
wherein the first concentric layer and the inner conduit concentric layer each independently comprise a polyamide (“PA”), polyvinyl chloride (“PVC”), polybutylene terephthalate (“PBT”), polyethylene terephthalate (“PET”), polystyrene (“PS”), polypropylene (“PP”), polyvinylidene fluoride (“PVDF”), polytetrafluoroethylene (“PTFE”), polyethylene oxide (“PEO”), high-density polyethylene (“HDPE”), or combinations thereof, and
wherein the second concentric layer and the outer conduit concentric layer each independently comprise thermoplastic polyurethane (“TPU”), thermoplastic elastomer (“TPE”), poly-2,6-dimethylphenylene oxide (“PPO”), polyvinyl methyl ether, polyvinyl chloride (“PVC”), polyetherimide (“PEI”), polymethyl methacrylate (“PMMA”), polyacrylic acid (“PAA”), polyether ketone, or combinations thereof.
